(19) United States
(12) Patent Application Publication
(10) Pub. No.: US 2026/0257241 A1
(43) Pub. Date: Sep. 3, 2026

(54) Protective Film, Method For Manufacturing Protective Film, And Electronic Device

(71) Applicant: Samsung Display Co., Ltd., Yongin-si, (KR)

(72) Inventor: Jonghwan Cho, Yongin-si (KR)

(73) Assignee: Samsung Display Co., Ltd., Yongin-si, (KR)

(21) Appl. No.: 19/551,785

(22) Filed: Feb. 27, 2026

(30) Foreign Application Priority Data
Feb. 28, 2025 (KR) 10-2025-0027001
May 16, 2025 (KR) 10-2025-0063668

(51) Int. Cl. B05D 5/06; B05D 1/00; B05D 7/00; B29D 11/00; G02B 1/111; G02B 1/14; G02B 5/22; H04M 1/02

(52) U.S. Cl. CPC B05D 5/06; B05D 1/60; B05D 7/52; B29D 11/00788; G02B 1/111; G02B 1/14; G02B 5/223; H04M 1/0214; H04M 1/0268; B05D 2320/00; B05D 2506/10

(57) ABSTRACT

A protective film may include a base layer, a hard coating layer disposed on the base layer, and an anti-reflective layer disposed on the hard coating layer. The hard coating layer or the anti-reflective layer may include a blue-light absorber, thereby providing a low reflective characteristic and also a blue-light blocking characteristic. An electronic device may include the protective film.

### CROSS-REFERENCE TO RELATED APPLICATIONS

This U.S. non-provisional patent application claims priority under 35 U.S.C. § 119 to Korean Patent Application No. 10-2025-0027001, filed on Feb. 28, 2025, and Korean Patent Application No. 10-2025-0063668, filed on May 16, 2025, the entire contents of each of which are incorporated by reference herein.

### TECHNICAL FIELD

The present disclosure herein relates to a protective film, a method for manufacturing the protective film, and an electronic device.

### BACKGROUND

Various electronic devices such as televisions, mobile phones, tablet computers, computers, and game consoles, are being developed. Recently, flexible electronic devices including flexible display panels capable of folding, rolling, or sliding are being developed. The flexible electronic devices may be variously changed in shape, for example, being folded, rolled, or bent, and thus may be portable regardless of sizes of screens for display.

The electronic devices may include display devices for providing image information, and blue light emitted from the display devices may increase eye strain of users and may cause amblyopia.

### SUMMARY

The present disclosure provides a protective film capable of reducing blue light, and a method for manufacturing the protective film.

The present disclosure also provides an electronic device capable of protecting eye health of users and with improved display quality.

An aspect of the present disclosure provides a protective film including a base layer, a hard coating layer disposed on the base layer, and an anti-reflective layer disposed on the hard coating layer. The hard coating layer or the anti-reflective layer includes at least one blue-light absorber selected from a benzoxazole-based compound, a phenyltriazine-based compound, and a naphthalimide-based compound.

In an aspect, the anti-reflective layer may include the blue-light absorber and a fluorine-based acrylate compound.

In an aspect, the fluorine-based acrylate compound may include a polymer represented by Formula 1.

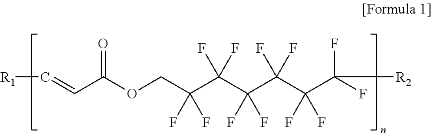

In Formula 1, R₁ and R₂ are each independently a hydrogen atom or a binding site to a neighboring atom, and n is an integer of 1 to 8.

For example, n in Formula 1 may be 8.

In an aspect, based on a total weight of 100 wt % of the blue-light absorber and the fluorine-based acrylate compound, the anti-reflective layer may include about 0.2 wt % to about 2.0 wt % of the blue-light absorber and about 98 wt % to about 99.8 wt % of the fluorine-based acrylate compound.

In an aspect, the hard coating layer may include the blue-light absorber, and the anti-reflective layer may not include the blue-light absorber.

In an aspect, the benzoxazole-based compound may include 2,5-Bis(5-tert-butyl-2-benzoxazolyl)thiophene.

In an aspect, the phenyltriazine-based compound may include at least one of 2-(2-Hydroxyphenyl)-1,3,5-triazine-4,6-diamine or 2,4,6-Tris(4-butoxy-2-hydroxyphenyl)-1,3,5-triazine.

In an aspect, the naphthalimide-based compound may include at least one of N-Hydroxy-1,8-naphthalimide or N-(Trifluoromethylsulfonyloxy)-1,8-naphthalimide.

In an aspect, a thickness of the anti-reflective layer may be about 90 nm to about 110 nm.

In an aspect, the anti-reflective layer may be formed by a vapor deposition polymerization method.

In an aspect of the present disclosure, a method for manufacturing a protective film includes providing a hard coating layer-forming material on a base layer to form a hard coating layer, and providing an anti-reflective layer-forming material on the hard coating layer to form an anti-reflective layer. The hard coating layer-forming material or the anti-reflective layer-forming material includes at least one blue-light absorber selected from a benzoxazole-based compound, a phenyltriazine-based compound, and a naphthalimide-based compound.

In an aspect, the forming of the anti-reflective layer may be performed in a vacuum chamber, and the anti-reflective layer-forming material may include the blue-light absorber and a fluorine-based acrylate compound.

In an aspect, the forming of the anti-reflective layer may include polymerizing the fluorine-based acrylate compound and simultaneously depositing the polymerized fluorine-based acrylate compound and the blue-light absorber on the hard coating layer.

In an aspect, the blue-light absorber and the fluorine-based acrylate compound may be provided at an ion acceleration voltage of about 100 V to about 500 V.

In an aspect, the forming of the anti-reflective layer may be performed at a temperature of about −30° C. to about 10° C.

In an aspect of the present disclosure, an electronic device includes a display module including a folding area, and a first non-folding area and a second non-folding area which are spaced apart from each other with the folding area indisposed therebetween, and a window module disposed on the display module and including a window glass and the above-described protective film which are stacked in sequence.

In an aspect, the electronic device may further include at least one of a processor, a memory, or a power module.

In an aspect, the hard coating layer may not include the blue-light absorber, and the anti-reflective layer may include the blue-light absorber and a fluorine-based acrylate compound.

In an aspect, the blue-light absorber may include at least one of compounds in Compound Group 1.

### BRIEF DESCRIPTION OF THE FIGURES

The accompanying drawings are included to provide a further understanding of aspects of the present disclosure, and are incorporated in and constitute a part of this specification. The drawings illustrate aspects of the present disclosure and, together with the description, serve to explain principles of the present disclosure. In the drawings:

FIG. 1A is a block diagram of an electronic device according to an aspect;

FIG. 1B is a schematic view of electronic devices according to various aspects;

FIG. 2A is a perspective view of an electronic device according to an aspect;

FIG. 2B is a perspective view of an electronic device according to an aspect;

FIG. 2C is a perspective view of an electronic device according to an aspect;

FIG. 3A is a perspective view of an electronic device according to an aspect;

FIG. 3B is a perspective view of an electronic device according to an aspect;

FIG. 3C is a perspective view of an electronic device according to an aspect;

FIG. 4 is an exploded perspective view of an electronic device according to an aspect;

FIG. 5 is a cross-sectional view illustrating a display device according to an aspect;

FIG. 6 is a cross-sectional view of a protective film according to an aspect;

FIG. 7A is a schematic view illustrating a step of a method of manufacturing a protective film according to an aspect; and

FIG. 7B is a schematic view illustrating a step of a method of manufacturing a protective film according to an aspect.

### DETAILED DESCRIPTION

In this specification, it will be understood that when an element (or a region, a layer, a portion, or the like) is referred to as being “on”, “connected to” or “coupled to” another element, it may be directly disposed on, connected to, or coupled to the other element, or other elements may be disposed therebetween.

Like reference numerals or symbols refer to like elements throughout. In the drawings, the thickness, ratio, and size of the elements are exaggerated for effectively describing the technical contents. The term “and/or” includes one or more combinations which may be defined by relevant elements.

It will be understood that, although the terms “first”, “second”, etc. may be used herein to describe various elements, the elements are not to be limited by these terms. These terms are only used to distinguish one element from another element. For instance, a first element discussed below could be termed a second element without departing from the scope of the present disclosure. Similarly, a second element could be termed a first element. In this specification, the singular expressions “a”, “an” and “the” are intended to include the plural forms as well, unless the context clearly indicates otherwise.

In addition, the terms “below”, “under”, “on the lower side”, “above”, “over”, “on the upper side”, or the like may be used to describe the relationships between the elements illustrated in the drawings. These terms are relative concepts and are described on the basis of the directions indicated in the drawings.

It will be further understood that the terms “comprises, includes, has” and/or “comprising, including, having”, when used in this specification, specify the presence of stated features, numbers, steps, operations, elements, components or combinations thereof, but do not preclude the possibility of the presence or addition of one or more other features, numbers, steps, operations, elements, components, and/or combinations thereof.

As used herein, “being directly disposed” may mean that there is no additional layer, film, region, plate or the like between a part such as a layer, film, region, plate or the like and another part. For example, “being directly disposed” may mean that two layers or two members are disposed with no additional member such as an adhesive member.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, aspects are described with reference to the drawings.

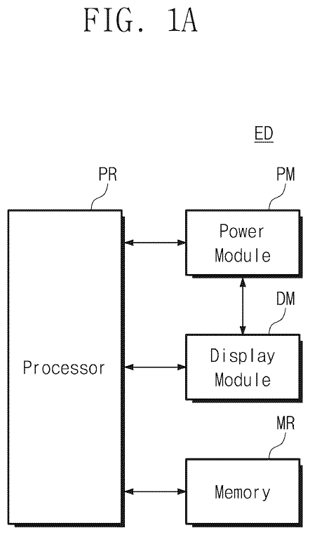

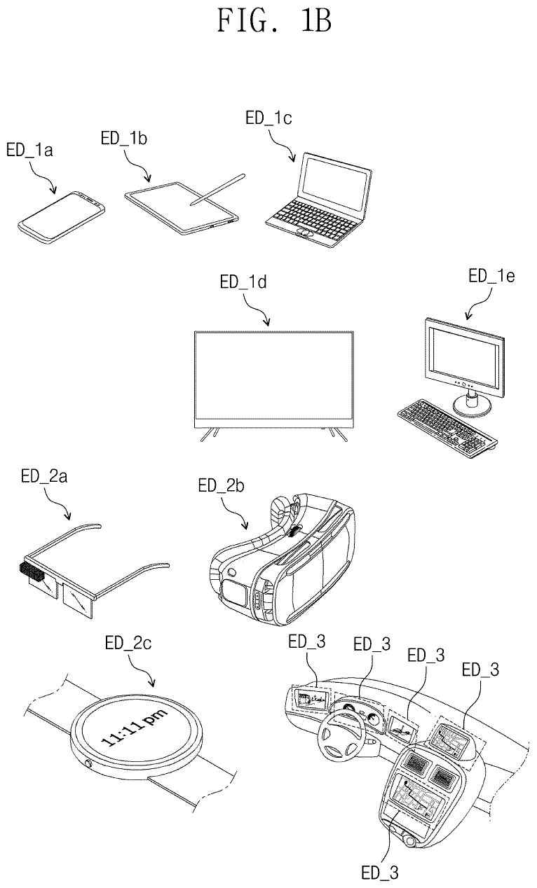

FIG. 1A is a block diagram of an electronic device ED according to an aspect. Referring to FIG. 1A, the electronic device ED according to an aspect may include a display module DM, a processor PR, a memory MR, and a power module PM.

The processor PR may include at least one of a central processing unit (CPU), an application processor (AP), a graphic processing unit (GPU), a communication processor (CP), an image signal processor (ISP), or a controller.

The memory MR may store data information necessary for an operation of the processor PR or the display module DM. When the processor PR executes an application stored in the memory MR, an image data signal and/or an input control signal may be transmitted to the display module DM, and the display module DM may process the received signal and output image information through a display screen.

The power module PM may include a power supply module such as a power adapter or a battery device, and a power conversion module which converts the power supplied by the power supply module and generates power necessary for an operation of the electronic device ED.

At least one of the foregoing components of the electronic device ED may be included in the display module DM according to an aspect. In addition, some of individual modules included as functional in one module may be included in the display module, and others may be provided separately from the display module. The processor PR, the memory MR, and the power module PM may be provided not in the display module but in another type of device in the electronic device ED.

FIG. 1B is a schematic view of electronic devices according to various aspects.

Referring to FIG. 1B, various electronic devices to which a display module is applied according to aspects may include not only an electronic device for image display, e.g., a smartphone ED_1a, a tablet PC ED_1b, a laptop computer ED_1c, TV ED_1d, or a monitor for a desk computer ED_1e, but also a wearable electronic device including a display module, e.g., smart glasses ED_2a, a head mounted display ED_2b, or a smartwatch ED_2c, or a vehicle electronic device ED_3 including a display module, e.g., a vehicle instrument panel, a center fascia, a center information display (CID) disposed on a dashboard, or a room mirror display.

The display module according to an aspect may be applied to various electronic devices. The electronic device according to an aspect may further include a module or device having another additional function in addition to the display module.

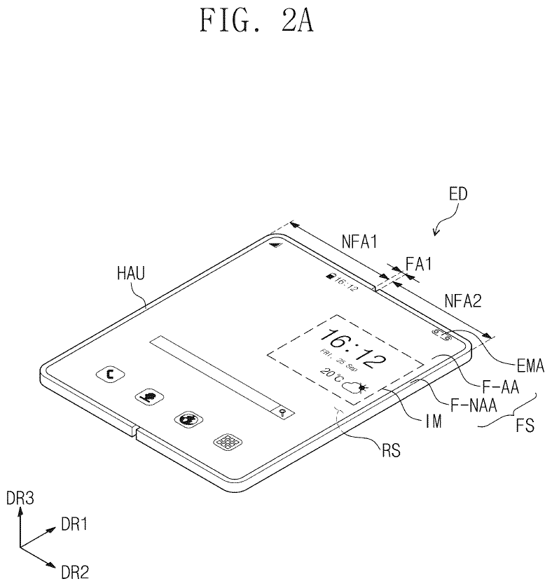

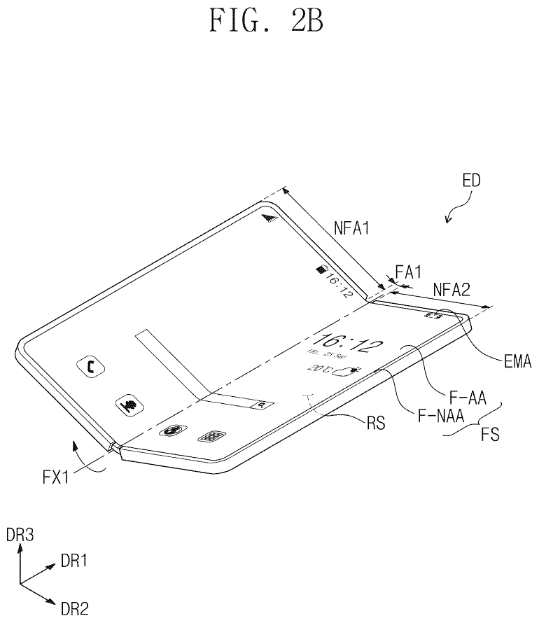

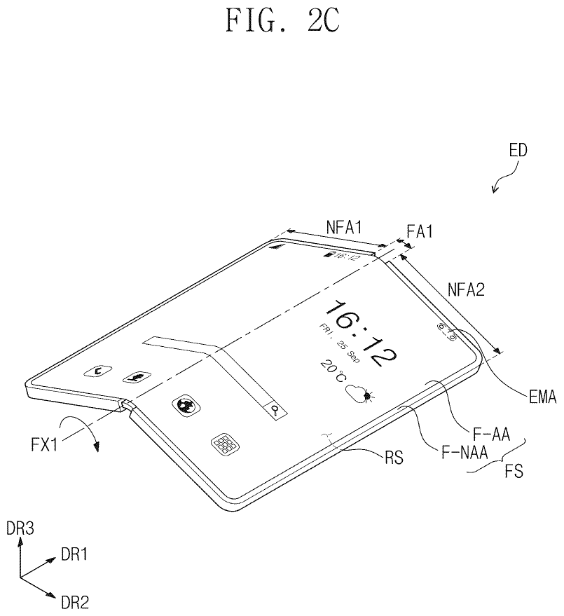

FIGS. 2A to 2C are each a perspective view of an electronic device ED according to an aspect. FIG. 2A is a perspective view illustrating an unfolded state of an electronic device according to an aspect. FIG. 2B is a perspective view illustrating an in-folding operation of the electronic device illustrated in FIG. 2A. FIG. 2C is a perspective view illustrating an out-folding operation of the electronic device illustrated in FIG. 2A.

An electronic device ED according to an aspect may be a device which is activated in response to an electrical signal. For example, the electronic device may include not only a large-sized electronic device such as a television, a monitor, or an outdoor billboard, but also a small or medium-sized device such as a personal computer, a notebook computer, a personal digital assistant, a vehicle navigation unit, a game console, a tablet computer, a smartwatch, or a camera, but aspects of the present disclosure are not limited thereto. FIG. 2A and the subsequent drawings herein illustrate smartphones as an example of electronic devices ED and ED-a.

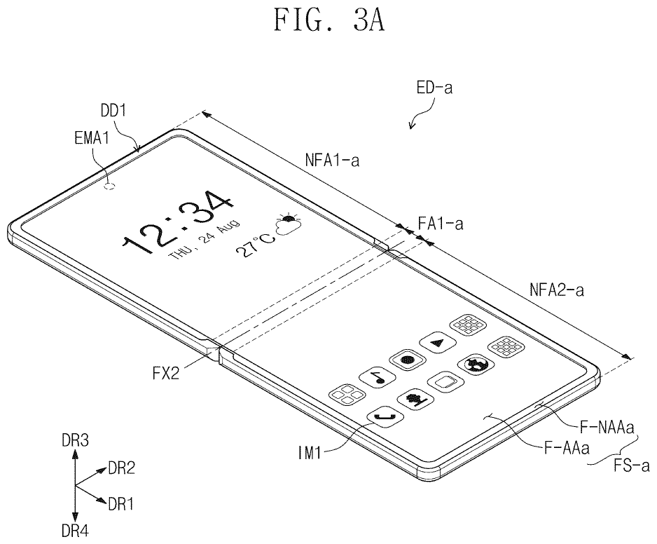

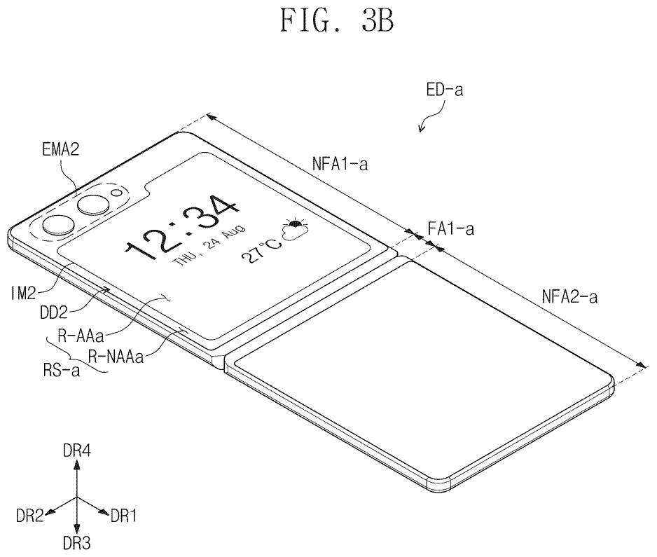

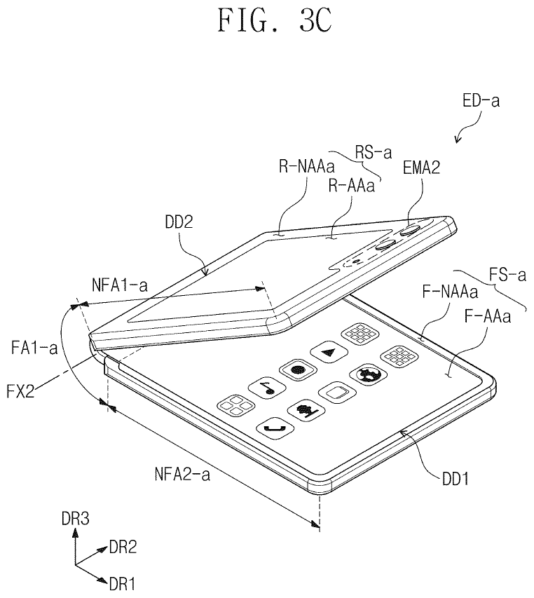

FIG. 2A and the subsequent drawings illustrate a first directional axis DR1 to a fourth directional axis DR4, and directions indicated by the first to fourth directional axis DR1, DR2, DR3 and DR4 used herein are relative concepts and may be changed to other directions. In addition, the directions indicated by the first to fourth directional axis DR1, DR2, DR3 and DR4 may be referred to as first to fourth directions DR1, DR2, DR3 and DR4 and may be designated by like reference symbols. As used herein, the first directional axis DR1 and the second directional axis DR2 perpendicularly cross each other, and the third directional axis DR3 may be a normal direction to a plane defined by the first directional axis DR1 and the second directional axis DR2. In addition, the direction of the fourth directional axis DR4 (see FIG. 3A and the like) means an opposite direction to the direction of the third directional axis DR3. The direction indicated by the fourth directional axis DR4 (see FIG. 3A and the like) may be referred to as a fourth direction DR4 and may be designated by like reference symbol.

As used herein, a cross-section means a surface parallel to a thickness direction DR3, and a plane means a surface perpendicular to the thickness direction DR3. The plane means a plane defined by the first directional axis DR1 and the second directional axis DR2. The term “on a plane” used herein may be defined as being in a state when viewed in the third direction DR3.

Referring to FIGS. 2A to 2C, the electronic device ED according to an aspect may include a first display surface FS defined by the first directional axis DR1 and the second directional axis DR2 crossing the first directional axis DR1. The electronic device ED may provide an image IM for a user through the first display surface FS. The electronic device ED according to an aspect may display the image IM toward the direction of the third directional axis DR3 on the first display surface FS parallel to each of the first directional axis DR1 and the second directional axis DR2. As used herein, a front surface (or top surface) and a rear surface (or bottom surface) of each component are defined on the basis of a direction in which the image IM is displayed. The front surface and the rear surface may oppose each other in the third directional axis DR3, and a normal direction to each of the front surface and the rear surface may be parallel to the third directional axis DR3.

The electronic device ED according to an aspect may include the first display surface FS and a second display surface RS. The first display surface FS may include an electronic module area EMA. The second display surface RS may be defined as a surface opposing at least a portion of the first display surface FS. That is, the second display surface RS may be defined as a portion of a rear surface of the electronic device ED.

The electronic device ED according to an aspect may detect an external input applied from the outside. The external input may include various types of inputs provided from the outside of the electronic device ED. For example, the external input may include not only a touch by part of the body, such as a user's hand, but also an external input (e.g., hovering) applied by approaching the electronic device ED or being adjacent thereto by a certain distance. In addition, the external input may include various types such as force, pressure, temperature, and light.

The first display surface FS of the electronic device ED may include an active area F-AA and a peripheral area F-NAA. The active area F-AA may be an area which is activated in response to an electrical signal. The electronic device ED may display the image IM through the active area F-AA of the first display surface FS. In addition, the electronic device ED may detect various types of external inputs in the active area F-AA of the first display surface FS.

The peripheral area F-NAA may be adjacent to the active area F-AA. A light transmittance of the peripheral area F-NAA may be lower than a light transmittance of the active area F-AA. The peripheral area F-NAA may have a certain color. The peripheral area F-NAA may surround the active area F-AA. Accordingly, a shape of the active area F-AA may be substantially defined by the peripheral area F-NAA. However, this is illustrative, and the peripheral area F-NAA may be disposed adjacent to only one side of the active area F-AA or may be omitted.

The electronic device ED may include a folding area FA1 and non-folding areas NFA1 and NFA2. In an aspect, the non-folding areas NFA1 and NFA2 may be disposed adjacent to the folding area FA1 with the folding area FA1 indisposed therebetween. The electronic device ED according to an aspect may include a first non-folding area NFA1 and a second non-folding area NFA2 which are spaced apart from each other in the direction of the second directional axis DR2 with the folding area FA1 indisposed therebetween.

Although FIGS. 2A to 2C illustrate an aspect of the electronic device ED including one folding area FA1, aspects of the present disclosure are not limited thereto, and a plurality of folding areas may be defined in the electronic device ED. For example, the electronic device according to an aspect may include two or more folding areas, and also three or more non-folding areas disposed with each of the folding areas indisposed therebetween.

Referring to FIG. 2B, the electronic device ED according to an aspect may be folded around a first folding axis FX1. The first folding axis FX1 is a virtual axis extending in the direction of the first directional axis DR1, and the first folding axis FX1 may be parallel to a long-side direction of the electronic device ED. The first folding axis FX1 may extend along the first directional axis DR1 on the first display surface FS.

The electronic device ED may be folded around the first folding axis FX1 and changed into an in-folded state in which one area, which overlaps the first non-folding area NFA1, of the first display surface FS and the other area, which overlaps the second non-folding area NFA2, of the first display surface FS face each other.

In a state in which the electronic device ED according to an aspect is in-folded, the second display surface RS may be visible to a user. The second display surface RS may further include an electronic module area EMA in which an electronic module including various components is disposed, and is not limited to any one aspect.

Referring to FIG. 2C, the electronic device ED according to an aspect may be folded around the first folding axis FX1 and changed into an out-folded state in which one area, which overlaps the first non-folding area NFA1, of the second display surface RS and the other area, which overlaps the second non-folding area NFA2, of the second display surface RS face each other.

However, aspects of the present disclosure are not limited thereto. The electronic device ED may be folded around a plurality of folding axes and thus folded so that respective portions of the first display surface FS and the second display surface RS face each other, and the number of the folding axes and the resulting number of the non-folding areas are not particularly limited.

Various electronic modules may be disposed in the electronic module area EMA. For example, the electronic module may include at least one of a camera, a speaker, a light detecting sensor, or a heat detecting sensor. The electronic module area EMA may detect an external subject received through the first display surface FS and/or the second display surface RS, or provide the outside with a sound signal such as voice, through the first display surface FS and/or the second display surface RS. The electronic module may include a plurality of components and is not limited to any one aspect.

FIGS. 3A to 3C are each a perspective view of an electronic device ED-a according to an aspect. FIG. 3A is a perspective view illustrating an unfolded state of the electronic device ED-a according to an aspect. FIG. 3B is a backside perspective view of the electronic device ED-a illustrated in FIG. 3A. FIG. 3C is a perspective view for describing an in-folding operation of the electronic device ED-a illustrated in FIG. 3A.

Referring to FIGS. 3A to 3C, the electronic device ED-a according to an aspect may include a first display device DD1 and a second display device DD2. The first display device DD1 and the second display device DD2 may be separate devices separated from each other. An area of a display surface of the second display device DD2 may be smaller than an area of a display surface of the first display device DD1. The first display device DD1 may be referred to as a main display device, and the second display device DD2 may be referred to as an auxiliary display device or an external display device.

The electronic device ED-a may include a first display surface FS-a and a second display surface RS-a. The first display device DD1 may include the first display surface FS-a defined by the first directional axis DR1 and the second directional axis DR2 crossing the first directional axis DR1. The first display device DD1 may provide a first image IM1 for a user through the first display surface FS-a. The first display device DD1 may display the first image IM1 toward the direction of the third directional axis DR3 on the first display surface FS-a parallel to each of the first directional axis DR1 and the second directional axis DR2.

The second display device DD2 may include the second display surface RS-a. The second display device DD2 may provide a second image IM2 for the user through the second display surface RS-a. The second display surface RS-a may be defined as a surface opposing at least a portion of the first display surface FS-a. That is, the second display surface RS-a may be defined as a portion of a rear surface of the electronic device ED-a. Thus, in a state in which the electronic device ED-a according to an aspect is unfolded, the first image IM1 displayed on the first display surface FS-a and the second image IM2 displayed on the second display surface RS-a may be displayed in opposite directions.

The first display surface FS-a may include a first active area F-AAa and a first peripheral area F-NAAa. The first active area F-AAa may include a first electronic module area EMA1. The first active area F-AAa may be an area which is activated in response to an electrical signal. The electronic device ED-a according to an aspect may display the first image IM1 through the first active area F-AAa. In addition, the first active area F-AAa may detect various types of external inputs.

The first peripheral area F-NAAa may be an area on which the first image IM1 is not displayed. The first peripheral area F-NAAa may be adjacent to the first active area F-AAa. The first peripheral area F-NAAa may have a certain color. The first peripheral area F-NAAa may surround the first active area F-AAa. Accordingly, a shape of the first active area F-AAa may be substantially defined by the first peripheral area F-NAAa. However, this is illustrated as an example, and the first peripheral area F-NAAa may be disposed adjacent to only one side of the first active area F-AAa or may be omitted. The electronic device ED-a according to an aspect may include the first active area F-AAa in various shapes and is not limited to any one aspect.

The second display surface RS-a may include a second active area R-AAa which displays the second image IM2. The second active area R-AAa may be an area which is activated in response to an electrical signal. The electronic device ED-a may display the second image IM2 through the second active area R-AAa. In addition, the electronic device ED-a may detect various types of external inputs in the second active area R-AAa.

The second display surface RS-a may include a second peripheral area R-NAAa. The second peripheral area R-NAAa may be adjacent to the second active area R-AAa. The second peripheral area R-NAAa may have a certain color. The second peripheral area R-NAAa may surround the second active area R-AAa. In addition, the second display surface RS-a may include a second electronic module area EMA2 in which an electronic module including various components is disposed. The second electronic module area EMA2 may be included in the second peripheral area R-NAAa. The second electronic module area EMA2 may be also disposed within the second active area R-AAa and is not limited to any one aspect.

Various electronic modules may be disposed in the first and second electronic module areas EMA1 and EMA2. For example, the electronic modules may include at least one of a camera, a speaker, a light detecting sensor, or a heat detecting sensor. Each of the first and second electronic module areas EMA1 and EMA2 may detect an external subject received through the first display surface FS-a or the second display surface RS-a, or provide the outside with a sound signal such as voice, through the first display surface FS-a or the second display surface RS-a. The electronic module may include a plurality of components and is not limited to any one aspect.

The electronic device ED-a may include a folding area FA1-a and non-folding areas NFA1-a and NFA2-a. In an aspect, the non-folding areas NFA1-a and NFA2-a may be disposed adjacent to the folding area FA1-a with the folding area FA1-a indisposed therebetween. The electronic device ED-a may include a first non-folding area NFA1-a and a second non-folding area NFA2-a which are arranged to be spaced apart from each other in the first direction DR1 with the folding area FA1-a indisposed therebetween. For example, the first non-folding area NFA1-a may be disposed on one side of the folding area FA1-a along the first direction DR1, and the second non-folding area NFA2-a may be disposed on the other side of the folding area FA1-a along the first direction DR1.

The first display device DD1 may include the folding area FA1-a and the non-folding areas NFA1-a and NFA2-a. The first display surface FS-a of the first display device DD1 may overlap the folding area FA1-a and the non-folding areas NFA1-a and NFA2-a. The second display device DD2 may overlap one of the plurality of non-folding areas NFA1-a and NFA2-a. For example, the second display device DD2 may overlap the first non-folding area NFA1-a. The second display device DD2 may not overlap the folding area FA1-a and the second non-folding area NFA2-a. The second display surface RS-a of the second display device DD2 may overlap the first non-folding area NFA1-a.

A display direction of the first image IM1 displayed on a portion of the first display device DD1, for example, the first non-folding area NFA1-a, may be an opposite direction to a display direction of the second image IM2 displayed on the second display device DD2. For example, in a state in which the electronic device ED-a is unfolded, the first image IM1 may be displayed in the third direction DR3, and the second image IM2 may be displayed in the fourth direction DR4 that is an opposite direction to the third direction DR3.

Although FIGS. 2A to 3C illustrate aspects of the electronic devices ED and ED-a each including one folding area FA1 or FA1-a, aspects of the present disclosure are not limited thereto, and a plurality of folding areas may be defined in each of the electronic devices ED and ED-a. For example, the electronic device according to an aspect may include two or more folding areas, and also three or more non-folding areas disposed with each of the folding areas indisposed therebetween.

Referring to FIG. 3C, the electronic device ED-a according to an embodiment may be folded around a second folding axis FX2. The second folding axis FX2 is a virtual axis extending in the second direction DR2, and the second folding axis FX2 may be parallel to a short-side direction of the electronic device ED-a. However, the second folding axis FX2 is not limited thereto and may be parallel to a long-side direction of the electronic device ED-a. The second folding axis FX2 may extend in the second direction DR2 on the first display surface FS-a.

The electronic device ED-a may be folded around the second folding axis FX2 and changed into an in-folded state in which one area, which overlaps the first non-folding area NFA1-a, of the first display surface FS-a and the other area, which overlaps the second non-folding area NFA2-a, of the first display surface FS-a face each other. The electronic device ED-a may be in-folded so that the first display surface FS-a is not exposed to the outside. In a state in which the electronic device ED-a is in-folded, the folding area FA1-a may have certain curvature and radius of curvature. In a state in which the electronic device ED-a is in-folded, the second display surface RS-a may be visible to the user, and the second image IM2 may be displayed in the third direction DR3.

In some aspects, the electronic device ED-a may be out-folded so that the first display device DD1 is exposed to the outside. The electronic device ED-a according to an aspect in the unfolded state may be in-foldable or also out-foldable and is not limited to any one aspect.

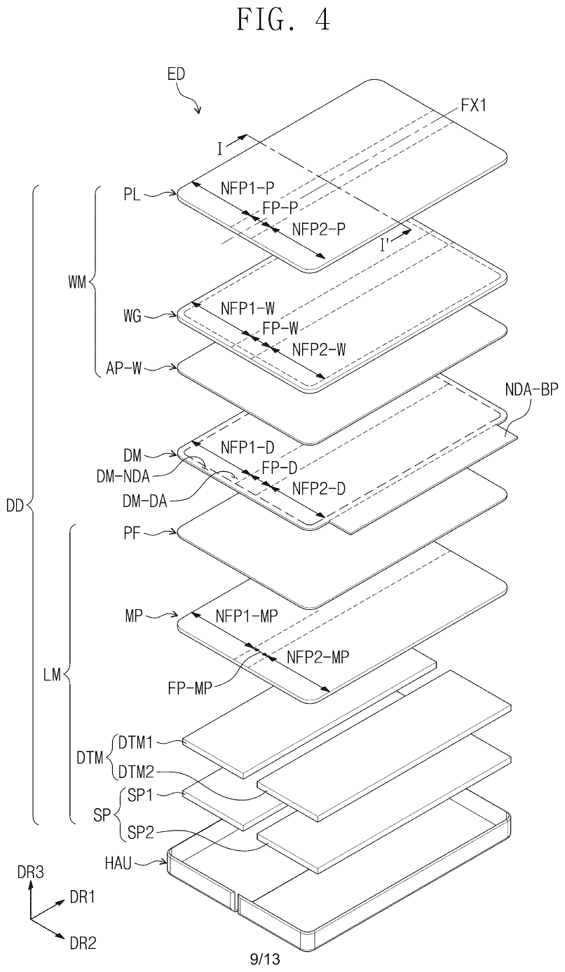

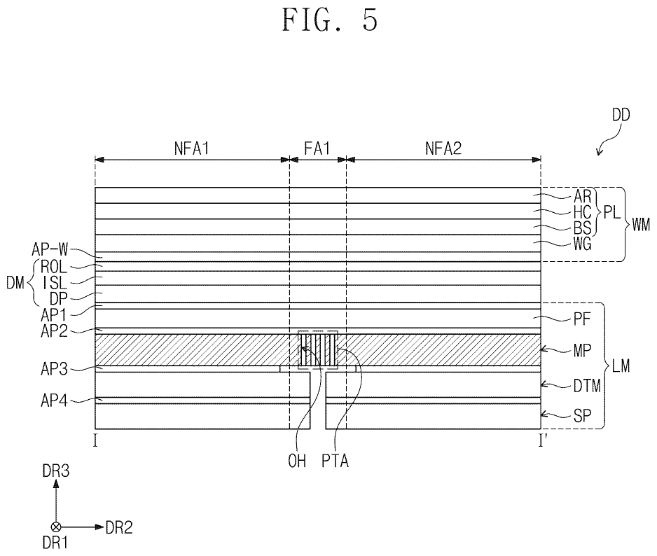

FIG. 4 is an exploded perspective view of an electronic device according to an aspect. The electronic device according to an aspect to be described with reference to FIG. 4 is described based on the electronic device ED illustrated in FIG. 2A. However, the description of a protective film according to an aspect and an electronic device including the protective film according to an aspect stated below may be applied to the case illustrated in FIG. 3A and the like, in which the folding axis FX1-a is parallel to the short side of the electronic device ED-a, or to various types of electronic devices such as multi-folded electronic devices. FIG. 4 is an exploded perspective view of an electronic device according to an aspect. FIG. 5 is a cross-sectional view illustrating a display device according to an aspect. FIG. 5 is a cross-sectional view illustrating a portion corresponding to line I-I′ in FIG. 4.

Referring to FIGS. 4 and 5, an electronic device ED according to an aspect may include a display device DD and a housing HAU. The display device DD may include a display module DM, a lower module LM, and a window module WM. The housing HAU may accommodate the display device DD.

The housing HAU may include a material having relatively high rigidity. For example, the housing HAU may include a plurality of frames and/or plates, each of which includes glass, plastic, or metal. The housing HAU may provide a certain accommodation space. The display module DM may be accommodated in the accommodation space of the housing HAU and be protected from an external impact.

The display module DM may display the image IM (see FIG. 2A) in response to an electrical signal, and transmit/receive information of an external input. A display area DM-DA and a non-display area DM-NDA may be defined in the display module DM.

The display area DM-DA may be defined as an area from which the image IM (see FIG. 2A) provided by the display module DM is output. The display area DM-DA of the display module DM may correspond to at least a portion of the active area F-AA (see FIG. 2A).

A driving circuit, a driving line, or the like for driving the display area DM-DA may be disposed in the non-display area DM-NDA. The non-display area DM-NDA may be adjacent to the display area DM-DA. For example, the non-display area DM-NDA may surround the display area DM-DA. However, this is illustrative, and the non-display area DM-NDA may be defined in various shapes and is not limited to any one aspect.

In addition, the display module DM may include a bending portion NDA-BP disposed on at least one side of the non-display area DM-NDA. The bending portion NDA-BP may be bent to a lower side of the display module DM and overlap at least a portion of the display module DM on a plane. A circuit layer, a connection line, a circuit board, or the like for displaying an image or transmitting/receiving information may be mounted on or attached to the bending portion NDA-BP.

The display module DM may include a folding display portion FP-D and non-folding display portions NFP1-D and NFP2-D. The folding display portion FP-D may be a portion corresponding to the folding area FA1 (see FIG. 2A), and the non-folding display portions NFP1-D and NFP2-D may be portions corresponding to the non-folding areas NFA1 and NFA2 (see FIG. 2A).

The non-folding display portions NFP1-D and NFP2-D may be divided into a first non-folding display portion NFP1-D and a second non-folding display portion NFP2-D. The first non-folding display portion NFP1-D and the second non-folding display portion NFP2-D may be spaced apart from each other in the second direction DR2 with the folding display portion FP-D interposed therebetween. As used herein, the folding display portion FP-D may be referred to as a folding portion, and the first and second non-folding display portions NFP1-D and NFP2-D may be referred to as first and second non-folding portions, respectively.

The display module DM may include a display panel DP and a sensor layer ISL. The display panel DP may be a component which substantially generates an image. The image generated by the display panel DP may be externally visible to a user through the first display surface FS (see FIG. 2A).

The display panel DP may be an emissive display layer but is not particularly limited. For example, the display panel DP may be an organic light emitting display layer or an inorganic light emitting display layer. The organic light emitting display layer may include a light emitting element in which an emission layer includes an organic light emitting material. In addition, the inorganic light emitting display layer may include a light emitting element in which an emission layer includes a material such as a quantum dot and a quantum rod. The display panel DP according to an aspect may include a light emitting element which emits blue light.

The sensor layer ISL may be directly disposed on the display panel DP. The sensor layer ISL may include a plurality of sensing electrodes. The sensor layer ISL may detect an external input to covert the external input to a certain input signal, and provide the input signal to the display panel DP. For example, the sensor layer ISL may be a touch sensing part which detects a touch. The sensor layer ISL may perceive a direct touch by a user, an indirect touch by a user, a direct touch by an object, an indirect touch by an object, or the like.

The sensor layer ISL may detect at least one of a position of a touch applied from the outside, or an intensity (pressure) of the touch. In an aspect, the sensor layer ISL may have various structures or include various materials, and is not limited to any one aspect. For example, the sensor layer ISL may detect an external input by using a capacitance method. The display panel DP may receive an input signal from the sensor layer ISL and generate an image corresponding to the input signal.

The sensor layer ISL may be directly formed on the display panel DP through a continuous process. However, aspects of the present disclosure are not limited thereto, and the sensor layer ISL may be manufactured as a separate panel from the display panel DP and be attached to the display panel DP through an adhesive layer (not illustrated).

The display module DM may further include an optical layer ROL. The optical layer ROL may function to reduce reflection of an external light. For example, the optical layer ROL may include a polarizing layer or a color filter layer. However, aspects of the present disclosure are not limited thereto, and the optical layer ROL may include optical members for improving display quality of the display module DM.

In an aspect, the optical layer ROL may be directly disposed on the sensor layer ISL. In addition, in a case in which the sensor layer ISL is omitted in the display module DM, the optical layer ROL may be directly disposed on the display panel DP. However, aspects of the present disclosure are not limited thereto, and the optical layer ROL may be disposed on the display panel DP or the sensor layer ISL by using a separate adhesive member.

The lower module LM may be disposed below the display module DM. The lower module LM may include a support plate MP. In addition, the lower module LM may further include at least one of a protective layer PF, a digitizer module DTM, or a support member SP.

The support plate MP may be disposed below the display panel DP. The support plate MP may include a folding support portion FP-MP and non-folding support portions NFP1-MP and NFP2-MP. The non-folding support portions NFP1-MP and NFP2-MP may be divided into a first non-folding support portion NFP1-MP and a second non-folding support portion NFP2-MP. The first non-folding support portion NFP1-MP and the second non-folding support portion NFP2-MP may be spaced apart from each other in the second direction DR2 with the folding support portion FP-MP interposed therebetween. The folding support portion FP-MP may be a portion corresponding to the folding area FA1 (see FIG. 2A), and the non-folding support portions NFP1-MP and NFP2-MP may be portions corresponding to the non-folding areas NFA1 and NFA2 (see FIG. 2A). The support plate MP may include a pattern portion PTA in which a plurality of openings OH are defined. The pattern portion PTA may be included in the folding support portion FP-MP. The pattern portion PTA may be arranged to correspond to the folding area FA1, thereby improving a folding or bending characteristic of the electronic device ED.

The protective layer PF may be disposed between the display module DM and the support plate MP. The protective layer PF may be disposed below the display module DM and protect a rear surface of the display module DM. The protective layer PF may overlap the entirety of the display module DM. The protective layer PF may include a polymer material. For example, the protective layer PF may be a polyimide film or a polyethylene terephthalate film. However, this is illustrative, and the material of the protective layer PF is not limited thereto.

The lower module LM may include the support member SP. The support member SP may include support layers SP1 and SP2. The support layers SP1 and SP2 may include a first support layer SP1 and a second support layer SP2 which are spaced apart from each other in the second direction DR2. The first support layer SP1 and the second support layer SP2 may be separated from each other at a portion corresponding to the first folding axis FX1 (see FIG. 2A). The support layers SP1 and SP2 may be separated from each other in the folding area FA1 and provided as the first support layer SP1 and the second support layer SP2, thereby improving the folding or bending characteristic of the electronic device ED. Although not illustrated, the support layers SP1 and SP2 may further include components such as a cushion layer (not illustrated) and a lower support plate (not illustrated) which are stacked in the thickness direction.

The electronic device ED according to an aspect may further include the digitizer module DTM. The digitizer module DTM may be included as a component of the lower module LM. The digitizer module DTM may be disposed below the support plate MP. For example, the digitizer module DTM may be disposed below the support plate MP and the support member SP. The digitizer module DTM according to an aspect may include components such as a digitizer layer and a shielding layer.

The digitizer module DTM may include a first digitizer module DTM1 and a second digitizer module DTM2 which are separated from each other at a portion overlapping the folding first axis FX1. The first digitizer module DTM1 may be arranged to correspond to the first non-folding area NFA1, and the second digitizer module DTM2 may be arranged to correspond to the second non-folding area NFA2. That is, in an embodiment, the first digitizer module DTM1 and the second digitizer module DTM2 may be separated from each other in an area overlapping the folding display portion FP-D. The first digitizer module DTM1 may overlap the first non-folding display portion NFP1-D, and the second digitizer module DTM2 may overlap the second non-folding display portion NFP2-D.

The window module WM may be disposed on the display module DM. The window module WM may include a folding window portion FP-W and non-folding window portions NFP1-W and NFP2-W. The non-folding window portions NFP1-W and NFP2-W may be divided into a first non-folding window portion NFP1-W and a second non-folding window portion NFP2-W. The first non-folding window portion NFP1-W and the second non-folding window portion NFP2-W may be spaced apart from each other in the second direction DR2 with the folding window portion FP-W interposed therebetween. The folding window portion FP-W may be a portion corresponding to the folding area FA1 of the electronic device ED, and the non-folding window portions NFP1-W and NFP2-W may be portions corresponding to the non-folding areas NFA1 and NFA2. In addition, the folding window portion FP-W may be a portion corresponding to the folding display portion FP-D, and the non-folding window portions NFP1-W and NFP2-W may be portions corresponding to the non-folding display portions NFP1-D and NFP2-D.

The electronic device ED according to an aspect may further include at least one adhesive layer AP1, AP2, AP3 or AP4. For example, a first adhesive layer AP1 may be disposed between the display panel DP and the protective layer PF, and a second adhesive layer AP2 may be disposed between the protective layer PF and the support plate MP. A third adhesive layer AP3 may be disposed between the support plate MP and the digitizer module DTM, and a fourth adhesive layer AP4 may be disposed between the digitizer module DTM and the support member SP. The at least one adhesive layer AP1, AP2, AP3 or AP4 may be an optically clear adhesive film or an optically clear adhesive resin layer. However, aspects of the present disclosure are not limited thereto, and the at least one adhesive layer AP1, AP2, AP3 or AP4 may be an adhesive layer having a low transmittance of about 80% or less.

Although FIG. 5 illustrates the lower module LM including all of the protective layer PF, the support plate MP, the support member SP, the adhesive layers AP1, AP2, AP3 and AP4, and the digitizer module DTM, aspects of the present disclosure are not limited thereto. In light of mechanical properties, shapes, operation characteristics, and the like required in the electronic device ED, only some of the foregoing components of the lower module LM may be selected, or components other than the foregoing components of the lower module LM may be added.

The window module WM may be disposed on the display module DM. The window module WM may cover the entirety of a top surface of the display module DM. In an aspect, the window module WM may be used as a cover window of the electronic device ED. The window module WM may include a window glass WG and a protective film PL.

The window glass WG may be optically transparent. The window glass WG may be disposed on the display panel DP. The window glass WG may exhibit a characteristic of being easy to repeat folding and unfolding. The window glass WG may be a strengthened glass substrate. The window glass WG may be an ultra-thin strengthened glass substrate.

The protective film PL may be disposed on the window glass WG. The protective film PL may include a base layer BS, a hard coating layer HC, and an anti-reflective layer AR. The base layer BS may be disposed on the window glass WG, and the hard coating layer HC may be disposed on the base layer BS. The anti-reflective layer AR may be disposed on the hard coating layer HC.

The protective film PL may include a folding portion FP-P and non-folding portions NFP1-P and NFP2-P. A first non-folding portion NFP1-P and a second non-folding portion NFP2-P of the protective film PL may be spaced apart from each other in the second direction DR2 with the folding portion FP-P interposed therebetween. The folding portion FP-P may be a portion corresponding to the folding area FA1 of the electronic device ED, and the non-folding portions NFP1-P and NFP2-P may be portions corresponding to the non-folding areas NFA1 and NFA2. In addition, the folding portion FP-P may be a portion corresponding to the folding window portion FP-W, and the non-folding portions NFP1-P and NFP2-P may be portions corresponding to the non-folding window portions NFP1-W and NFP2-W. In an aspect, the protective film PL may correspond to the uppermost member of the electronic device ED.

The window module WM may further include a window adhesive layer AP-W. The window adhesive layer AP-W may be provided below the window glass WG. The window adhesive layer AP-W may be disposed between the display module DM and the window glass WG. The window adhesive layer AP-W may include a pressure sensitive adhesive (PSA), an optically clear adhesive film (OCA), or an optically clear adhesive resin layer (OCR). However, this is illustrative, and aspects of the present disclosure are not limited thereto. Unlike the illustrated aspect, the window adhesive layer AP-W may be omitted.

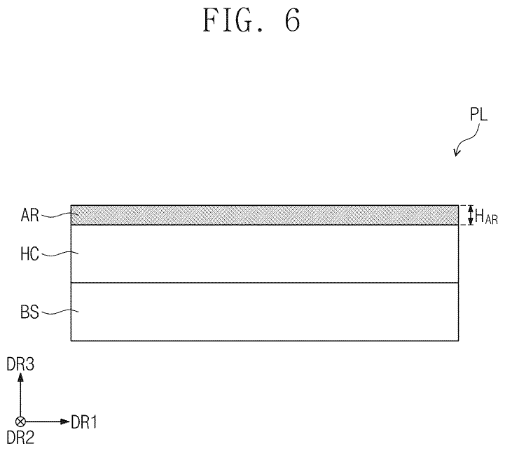

FIG. 6 is a cross-sectional view of a protective film according to an aspect. Referring to FIG. 6, a protective film PL includes a base layer BS, a hard coating layer HC, and an anti-reflective layer AR which are stacked in sequence in the third direction DR3 that is a thickness direction. In the protective film PL according to an aspect, the hard coating layer HC or the anti-reflective layer AR may include a blue-light absorber. In addition, the protective film PL may further include a functional layer (not illustrated). The functional layer may be disposed on the anti-reflective layer AR and may include an anti-fingerprint coating agent, an anti-static agent, or the like.

The base layer BS may be a member which provides a base surface on which the hard coating layer HC and the anti-reflective layer AR are disposed. The base layer BS may serve to support the hard coating layer HC and the anti-reflective layer AR, thereby improving durability of the protective film PL. The base layer BS may be transparent. The base layer BS may be a polymer film having flexibility. The base layer BS may include at least one of polyethylene terephthalate (PET), polyimide, polyacrylate, polymethylmethacrylate, polycarbonate, polyethylenenaphthalate, polyvinylidene chloride, polyvinylidene difluoride, polystyrene, or ethylene vinylalcohol copolymer. For example, the base layer BS may be polyethylene terephthalate (PET). In an aspect, a thickness of the base layer BS may be about 65 μm. However, this is illustrative, and the thickness of the base layer BS is not limited thereto.

The hard coating layer HC may be disposed on the base layer BS, and improve the durability of the protective film PL and impart structural intensity. The hard coating layer HC may include a blue-light absorber according to an aspect. The hard coating layer HC may include the blue-light absorber to provide an effect of blocking blue light. In addition, the hard coating layer HC may include a resin for hard coating made of at least one of an organic-based composition, an inorganic-based composition, or an organic/inorganic composite composition. For example, a hard coating agent constituting the hard coating layer HC may be a composition for hard coating which includes at least one of an acrylate-based compound, a siloxane compound, or a silsesquioxane compound. The hard coating layer HC may include a hard coating agent including the blue-light absorber according to an aspect as an additive.

In addition, the hard coating agent may further include an inorganic particle. In the hard coating agent, the inorganic particle may be provided to improve the hardness of the hard coating layer HC. The inorganic particle may include at least one of SiO₂, TiO₂, Al₂O₃, ZrO₂, ZnO, AlN, or Si₃N₄. The inorganic particle may be surface-treated with an organic material, such as silane, to increase dispersion in the composition for hard coating. For example, a thickness of the hard coating layer HC may be about 3 μm. However, this is illustrative, and the thickness of the hard coating layer HC is not limited thereto.

When the hard coating layer HC includes the blue-light absorber, the hard coating layer HC may include about 0.2 wt % to about 2 wt % of the blue-light absorber, based on a total weight of 100 wt % of the blue-light absorber and the hard coating agent. The hard coating layer HC may include about 0.2 wt % to about 2 wt % of the blue-light absorber based on a total weight of the hard coating layer HC. When the hard coating layer HC includes about 0.2 wt % to about 2 wt % of the blue-light absorber, an excellent blue-light blocking effect may be provided.

The anti-reflective layer AR may be directly disposed on the hard coating layer HC. The anti-reflective layer AR may be a coating layer which reduces reflectance of light and increases transmittance. The anti-reflective layer AR may be a layer which is disposed at the uppermost portion of the display device DD (see FIG. 5). The anti-reflective layer AR may include the blue-light absorber according to an aspect. The anti-reflective layer AR may include the blue-light absorber to provide the blue-light blocking effect.

When the anti-reflective layer AR includes the blue-light absorber, the hard coating layer HC may not include the blue-light absorber so that functions do not conflict. That is, the protective film PL according to an aspect may include the blue-light absorber in one of the hard coating layer HC and the anti-reflective layer AR, thereby providing the excellent blue-light blocking effect. Thus, the display device DD (see FIG. 5) according to an aspect may provide a blue-light blocking function even without a separate blue-light blocking film, and may prevent color tone distortion.

The anti-reflective layer AR and the hard coating layer HC may include, as the blue-light absorber, at least one selected from a benzoxazole-based compound, a phenyltriazine-based compound, or a naphthalimide-based compound. The term “a”-based compound used herein means a compound including a functional group of “a”. The blue light may correspond to a wavelength region of about 410 nm to about 480 nm or about 415 nm to about 455 nm.

For example, the benzoxazole-based compound may include 2,5-Bis(5-tert-butyl-2-benzoxazolyl)thiophene. The phenyltriazine-based compound may include at least one of 2-(2-Hydroxyphenyl)-1,3,5-triazine-4,6-diamine or 2,4,6-Tris(4-butoxy-2-hydroxyphenyl)-1,3,5-triazine. The naphthalimide-based compound may include at least one of N-Hydroxy-1,8-naphthalimide or N-(Trifluoromethylsulfonyloxy)-1,8-naphthalimide.

The blue-light absorber may include at least one of the compounds in Compound Group 1 below. The compounds in Compound Group 1 may exhibit excellent absorbance for the blue light in the wavelength region of about 410 nm to about 480 nm. One of the anti-reflective layer AR and the hard coating layer HC may include at least one of the compounds in Compound Group 1, thereby increasing a blocking ratio for the blue light emitted from the display device DD (see FIG. 5) and thus reducing eye strain caused by the blue light.

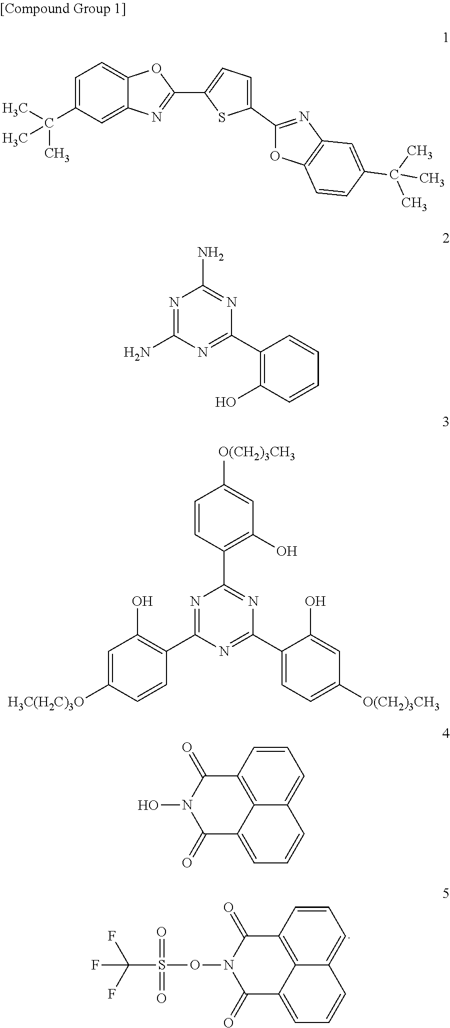

The anti-reflective layer AR may be a layer in which the blue-light absorber is dispersed in a base resin. The base resin constituting the anti-reflective layer AR may include a fluorine-based acrylate compound. The anti-reflective layer AR may include the base resin including the fluorine-based acrylate compound, and the blue-light absorber dispersed in the base resin.

The fluorine-based acrylate compound may include a fluorine-based monomer having a low-refractive characteristic. A refractive index of the fluorine-based acrylate compound may be about 1.2 to about 1.4. The anti-reflective layer AR may include, as the base resin, the fluorine-based acrylate compound having the refractive index of about 1.2 to about 1.4, thereby exhibiting an excellent anti-reflection characteristic. The fluorine-based acrylate compound according to an aspect may be represented by Formula 1.

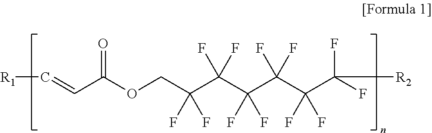

In Formula 1, R₁ and R₂ may be each independently a hydrogen atom or a binding site to a neighboring atom. In Formula 1, n may be an integer of 1 to 8.

For example, n in Formula 1 may be 8. The fluorine-based acrylate compound in which n in Formula 1 is 8 may correspond to a case in which a degree of polymerization of DodecaFluoroHeptyl Acrylate (DFHA) is 8. DodecaFluoroHeptyl Acrylate (DFHA) having the degree of polymerization of 8 may be represented by Formula 1-A, and may have a refractive index of about 1.342.

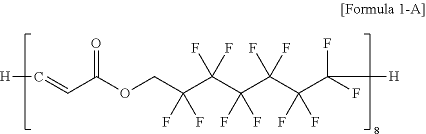

The anti-reflective layer AR may include about 0.2 wt % to about 2 wt % of the blue-light absorber, based on a total weight of 100 wt % of the blue-light absorber and the fluorine-based acrylate compound. In addition, the anti-reflective layer AR may include about 98 wt % to about 99.8 wt % of the fluorine-based acrylate compound, based on the total weight of 100 wt % of the blue-light absorber and the fluorine-based acrylate compound. For example, based on the total weight of the blue-light absorber and the fluorine-based acrylate compound, the anti-reflective layer AR may include about 2 wt % of the blue-light absorber and about 98 wt % of the fluorine-based acrylate compound.

When the anti-reflective layer AR includes the blue-light absorber and the fluorine-based acrylate compound in the foregoing ranges, respectively, the anti-reflective layer AR may effectively block the blue light and may exhibit the excellent anti-reflection characteristic. Compared to this, when the anti-reflective layer AR includes less than about 0.2 wt % of the blue-light absorber, the blue-light blocking ratio may be decreased to increase eye strain. When the anti-reflective layer AR includes more than about 2 wt % of the blue-light absorber, compatibility between the blue-light absorber and the fluorine-based acrylate compound may be decreased.

A thickness HAR of the anti-reflective layer AR may be about 90 nm to about 110 nm. For example, the thickness HAR of the anti-reflective layer AR may be about 110 nm. In the foregoing range of the thickness HAR, the anti-reflective layer AR may have the excellent anti-reflection characteristic and blue-light blocking characteristic, and folding and unfolding operations may be easily repeated. Thus, the electronic device ED (see FIG. 2A or the like) including the anti-reflective layer AR having the foregoing range of the thickness HAR may exhibit excellent reliability and display quality.

In an aspect, the anti-reflective layer AR may be formed by a vapor deposition polymerization method. In the vapor deposition polymerization method, it is possible to control a microstructure so that the anti-reflective layer AR having a nanometer-scale thickness is formed as a uniform thin film. Moreover, as the anti-reflective layer AR is formed by the vapor deposition polymerization method, a depolymerization may not occur in the base resin including the fluorine-based acrylate compound, and the base resin with the blue-light absorber uniformly dispersed therein may be deposited on the hard coating layer HC.

The blue-light blocking ratio of the anti-reflective layer AR and the hard coating layer HC, which include the blue-light absorber according to an aspect, may be about 35% or less. In addition, the anti-reflective layer AR and the hard coating layer HC may include the blue-light absorber according to an aspect, thereby exhibiting the blue-light blocking ratio of about 25% or less. Thus, the protective film PL including the anti-reflective layer AR and the hard coating layer HC according to an aspect may cause less change of a color tone and exhibit the excellent anti-reflection characteristic and blue-light blocking effect.

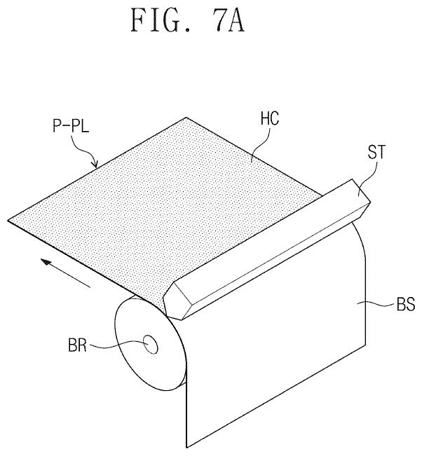

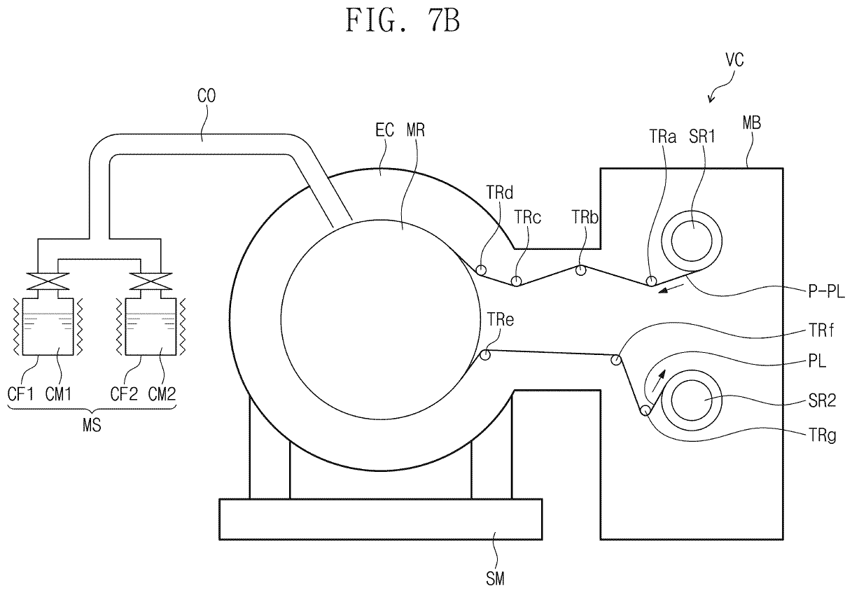

The protective film PL may be formed by a manufacturing method according to an aspect. FIGS. 7A and 7B are schematic views illustrating steps of manufacturing a protective film according to an aspect. Hereinafter, aspects are described with reference to FIGS. 7A and 7B by avoiding the contents in common with the contents described with reference to FIGS. 1A to 6, and mainly in terms of differences.

A method for manufacturing a protective film according to an aspect may include preparing a base layer, forming a hard coating layer, and forming an anti-reflective layer. A protective film PL manufactured by the method for manufacturing the protective film according to an aspect may be applied to the electronic devices ED and ED-a (see FIGS. 2B and 3A) each having at least one folding axis FX1 or FX2 (see FIGS. 2B and 3A).

FIG. 7A may be a view illustrating a step of forming a hard coating layer HC. Referring to FIG. 7A, a hard coating layer-forming material may be provided on a prepared base layer BS to form the hard coating layer HC. The hard coating layer-forming material may be provided on the base layer BS by using a slit coating method. The hard coating layer-forming material may be the hard coating agent described above.

For example, the hard coating agent may be supplied from a slit nozzle ST and provided on the base layer BS. The hard coating agent may have a viscosity suitable to be provided using the slit coating method. A back roll BR may be disposed below the base layer BS and arranged to oppose the slit nozzle ST with the base layer BS interposed therebetween. The back roll BR may be adjacent to, or in contact with, the slit nozzle ST and rotate in the same direction as a transfer direction (an arrow in FIG. 7A) of the base layer BS. The base layer BS may be transferred by the rotation of the back roll BR, and the hard coating agent may be provided on the base layer BS being transferred.

The hard coating agent provided on the base layer BS may be dried and/or cured to form the hard coating layer HC. The base layer BS on which the hard coating layer HC is formed may be a preliminary protective film P-PL. As described above, in a case in which the hard coating layer HC according to an aspect includes a blue-light absorber and an anti-reflective layer AR does not include the blue-light absorber, the hard coating agent may include the blue-light absorber as an additive.

FIG. 7B may be a view illustrating a step of forming the anti-reflective layer AR. Referring to FIG. 7B, the anti-reflective layer AR may be formed using a vapor deposition polymerization device VC. That is, the anti-reflective layer AR may be formed by a vapor deposition polymerization method.

The vapor deposition polymerization device VC may include a main body MB, a vacuum chamber EC, a pipe CO, a material supply part MS, and a support part SM. The vacuum chamber EC may be connected to the main body MB, and the pipe CO may be disposed between the vacuum chamber EC and the material supply part MS. An anti-reflective layer-forming material may be provided from the material supply part MS to the vacuum chamber EC through the pipe CO. The support part SM may be disposed below the vacuum chamber EC to support the vacuum chamber EC. The support part SM may be provided in plurality, and as long as the support part SM supports the vacuum chamber EC while withstanding the weight thereof, components, shape, and the like of the support part SM are not limited. Meanwhile, the configuration of the vapor deposition polymerization device VC illustrated in FIG. 7B are illustrative, and aspects of the present disclosure are not limited thereto.

A first roller SR1 and a second roller SR2 may be disposed inside the main body MB. The first roller SR1 and the second roller SR2 may be spaced apart from each other in one direction. The first roller SR1 may be disposed on an upper side, and the second roller SR2 may be disposed on a lower side. In one direction perpendicular to a plane, the first roller SR1 and the second roller SR2 may be arranged in one row, but the arrangement of the first roller SR1 and the second roller SR2 is not limited thereto. The first roller SR1 and the second roller SR2 may each rotate in the same direction as a process proceeding direction (arrows in FIG. 7B). For example, the first roller SR1 and the second roller SR2 may rotate clockwise.

A main roller MR may be disposed between the first roller SR1 and the second roller SR2. The main roller MR may be disposed in the vacuum chamber EC. The pipe CO may be disposed adjacent to the main roller MR. The main roller MR may rotate in an opposite direction to the first roller SR1 and the second roller SR2. The main roller MR may rotate counterclockwise. A plurality of sub-rollers TRa, TRb, TRc, TRd, TRe, TRf and TRg may be disposed between the first roller SR1 and the main roller MR, and between the second roller SR2 and the main roller MR. The sub-rollers TRa, TRb, TRc, TRd, TRe, TRf and TRg may be tension rollers.

In the method for manufacturing the protective film according to an aspect, the anti-reflective layer-forming material may be provided on the preliminary protective film P-PL to form the anti-reflective layer AR (see FIG. 6). The preliminary protective film P-PL may be provided to the first roller SR1 and be transferred by the sub-rollers TRa, TRb, TRc and TRd and the main roller MR.

The anti-reflective layer-forming material may be provided on the preliminary protective film P-PL moving along the main roller MR. The anti-reflective layer-forming material may be provided from the material supply part MS and may be transferred via the pipe CO to the preliminary protective film P-PL being on the main roller MR.

The material supply part MS may include a first reactor CF1 and a second reactor CF2. The first reactor CF1 and the second reactor CF2 may contain different materials. The first reactor CF1 may contain a first material CM1, and the second reactor CF2 may contain a second material CM2. The first material CM1 and the second material CM2 may correspond to the anti-reflective layer-forming material and be different materials.

The material supply part MS may further include a valve and a temperature controller. The valve may be connected to the first and second reactors CF1 and CF2 and the pipe CO, and control the supply of the materials contained in the first and second reactors CF1 and CF2. The temperature controller may be disposed adjacent to each of the first reactor CF1 and the second reactor CF2, and set temperature conditions of the first reactor CF1 and the second reactor CF2 so that the first material CM1 and the second material CM2 are provided at desired temperatures.

The first material CM1 may be a material for providing the base resin, and the second material CM2 may be a material for providing the blue-light absorber. About 0.2 wt % to about 2 wt % of the second material CM2, and about 98 wt % to about 99.8 wt % of the first material CM1 may be provided based on a total weight of 100 wt % of the first material CM1 and the second material CM2.

The first material CM1 may include the fluorine-based acrylate compound having the low refractive characteristic described above. The second material CM2 may include the blue-light absorber described above. The second material CM2 may include a single material or a plurality of materials. The second material CM2 may include at least one selected from a benzoxazole-based compound, a phenyltriazine-based compound, or a naphthalimide-based compound. In the method for manufacturing the protective film according to an aspect, the second material CM2 may be omitted when the blue-light absorber is added during the forming of the hard coating layer HC. That is, when the hard coating layer HC includes the blue-light absorber, the anti-reflective layer AR may include the first material CM1 but not include the second material CM2. When the second material CM2 is not added to the anti-reflective layer AR, only the first reactor CF1 may operate while the second reactor CF2 does not operate.

The protective film PL may be formed through a dry process. The first material CM1 and the second material CM2 may be provided at an ion acceleration voltage of about 100 V to about 500 V. The fluorine-based acrylate compound and the blue-light absorber may be provided at the ion acceleration voltage of about 100 V to about 500 V. In an ion acceleration voltage range of about 100 V to about 300 V, adhesion and wear resistance of the anti-reflective layer AR (see FIG. 6) may be improved as the ion acceleration voltage increases. In the ion acceleration voltage range of about 300 V to about 500 V, the anti-reflective layer AR (see FIG. 6) exhibiting improved adhesion and wear resistance may be formed regardless of the increase of the ion acceleration voltage.

For example, the fluorine-based acrylate compound and the blue-light absorber may be provided at the ion acceleration voltage of about 300 V. When the fluorine-based acrylate compound and the blue-light absorber are provided at the ion acceleration voltage of less than about 100 V, the anti-reflective layer may not be easily formed. When the fluorine-based acrylate compound and the blue-light absorber are provided at the ion acceleration voltage of more than about 500 V, an anti-reflective layer with low wear resistance may be formed. However, the method for manufacturing the protective film according to an aspect, the method including the providing of the fluorine-based acrylate compound and the blue-light absorber at the ion acceleration voltage of about 100 V to about 500 V, may exhibit excellent manufacturing reliability. The anti-reflective layer AR (see FIG. 6), which includes the fluorine-based acrylate compound and the blue-light absorber provided at the ion acceleration voltage of about 100 V to about 500 V, may exhibit excellent wear resistance and also exhibit excellent adhesion to the preliminary protective film P-PL.

The forming of the anti-reflective layer AR (see FIG. 6) may be performed at a temperature of about −30° C. to about 10° C. which is a temperature in the vacuum chamber EC. For example, the temperature in the vacuum chamber EC may be set to about −20° C. to perform the forming of the anti-reflective layer AR (see FIG. 6). When the anti-reflective layer is formed at a temperature of lower than about-30° C., molecular energies of the fluorine-based acrylate compound and/or the blue-light absorber may be low, and thus the anti-reflective layer may not be easily formed. When the anti-reflective layer is formed at a temperature of higher than about 10° C., an anti-reflective layer with low wear resistance may be formed. However, the method for manufacturing the protective film according to an aspect, the method including the forming of the anti-reflective layer AR at the temperature of about −30° C. to about 10° C., may exhibit excellent manufacturing reliability.

The fluorine-based acrylate compound of the first material CM1 and the blue-light absorber of the second material CM2 may be deposited on the preliminary protective film P-PL to form the anti-reflective layer AR. In the method for manufacturing the protective film according to an aspect, polymerizing the fluorine-based acrylate compound and dispersing the blue-light absorber in the polymerized fluorine-based acrylate compound to be deposited on the preliminary protective film P-PL may be simultaneously performed in the vacuum chamber EC. Accordingly, the method for manufacturing the protective film according to an aspect may exhibit excellent manufacturing efficiency.

The first material CM1 may be polymerized in the vacuum chamber EC, and the first material CM1 and the second material CM2 may be provided and deposited on the preliminary protective film P-PL moving along the main roller MR. The anti-reflective layer AR may be formed from the first material CM1 and the second material CM2 deposited on the preliminary protective film P-PL, thereby manufacturing the protective film PL. A thickness of the anti-reflective layer AR formed from the first material CM1 and the second material CM2 may be about 90 nm to about 110 nm. As the anti-reflective layer AR according to an aspect is formed by polymerizing and depositing the first material CM1 and the second material CM2 in the vacuum chamber EC, a nanometer-scale thin film may be manufactured in a uniform thickness. The manufactured protective film PL may be transferred to the main body MB through the main roller MR, the sub-rollers TRe, TRf and TRg, and the second roller SR2.

A protective film according to an aspect may include a base layer, a hard coating layer, and an anti-reflective layer which are stacked in sequence. In the protective film, the hard coating layer or the anti-reflective layer may include at least one blue-light absorber selected from a benzoxazole-based compound, a phenyltriazine-based compound, and a naphthalimide-based compound. Accordingly, the protective film according to an aspect may exhibit an anti-reflection characteristic and also provide an excellent blue-light blocking effect. Thus, an electronic device including the protective film according to an aspect may not only block the blue light to protect eye health of users, but also provide an image without color distortion to exhibit excellent display quality.

The protective film may be manufactured by a method for manufacturing a protective film according to an aspect. The method for manufacturing the protective film according to an aspect may include forming the hard coating layer and the anti-reflective layer, and the blue-light absorber may be provided in the forming of the hard coating layer or the forming of the anti-reflective layer. Accordingly, the method for manufacturing the protective film according to an aspect may manufacture the protective film having an excellent blue-light blocking effect.

The protective film according to the aspect may include the hard coating layer and the anti-reflective layer and include the specific blue-light absorber in the hard coating layer or the anti-reflective layer, thereby providing the blue-light blocking effect and the anti-reflection characteristic.

Moreover, the method for manufacturing the protective film according to the aspect may form the anti-reflective layer having the uniform thickness.

Moreover, the electronic device according to the aspect may include the forgoing protective film, and thus may not only block the blue light to protect eye health of users, but also provide the image without color distortion to exhibit the excellent display quality

In the above, description has been made with reference to aspects of the present disclosure, but those skilled or of ordinary skill in the art may understand that various modifications and changes may be made to the aspects of the present disclosure insofar as such modifications and changes do not depart from the spirit and technical scope of the present disclosure set forth in the claims to be described later. Therefore, the technical scope of the present disclosure is not to be limited to the contents stated in the detailed description of the specification, but should be determined by the claims.

What is claimed is:

1. A protective film comprising:
a base layer;
a hard coating layer disposed on the base layer; and
an anti-reflective layer disposed on the hard coating layer,
wherein the hard coating layer or the anti-reflective layer comprises at least one blue-light absorber comprising a benzoxazole-based compound, a phenyltriazine-based compound, or a naphthalimide-based compound.

2. The protective film of claim 1, wherein the anti-reflective layer comprises the blue-light absorber and a fluorine-based acrylate compound.

3. The protective film of claim 2, wherein the fluorine-based acrylate compound comprises a polymer represented by Formula 1: 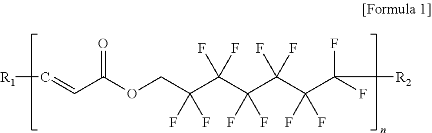
wherein, in Formula 1, R₁ and R₂ are each independently a hydrogen atom or a binding site to a neighboring atom, and
n is an integer of 1 to 8.

4. The protective film of claim 3, wherein n in Formula 1 is 8.

5. The protective film of claim 2, wherein the anti-reflective layer comprises:
about 0.2 wt % to about 2 wt % of the blue-light absorber; and
about 98 wt % to about 99.8 wt % of the fluorine-based acrylate compound, based on a total weight of the blue light absorber and the fluorine-based acrylate compound.

6. The protective film of claim 1, wherein the hard coating layer comprises the blue-light absorber.

7. The protective film of claim 1, wherein the at least one blue-light absorber comprises the benzoxazole-based compound and the benzoxazole-based compound comprises 2,5-Bis(5-tert-butyl-2-benzoxazolyl)thiophene.

8. The protective film of claim 1, wherein the at least one blue-light absorber comprises the phenyltriazine-based compound, and the phenyltriazine-based compound comprises at least one of 2-(2-Hydroxyphenyl)-1,3,5-triazine-4,6-diamine or 2,4,6-Tris(4-butoxy-2-hydroxyphenyl)-1,3,5-triazine.

9. The protective film of claim 1, wherein the at least one blue-light absorber comprises the naphthalimide-based compound, and the naphthalimide-based compound comprises at least one of N-Hydroxy-1,8-naphthalimide or N-(Trifluoromethylsulfonyloxy)-1,8-naphthalimide.

10. The protective film of claim 1, wherein a thickness of the anti-reflective layer is about 90 nm to about 110 nm.

11. The protective film of claim 1, wherein the anti-reflective layer is formed by a vapor deposition polymerization method.

12. A method for manufacturing a protective film, the method comprising:
providing a hard coating layer-forming material on a base layer to form a hard coating layer; and
providing an anti-reflective layer-forming material on the hard coating layer to form an anti-reflective layer,
wherein the hard coating layer-forming material or the anti-reflective layer-forming material comprises at least one blue-light absorber comprising a benzoxazole-based compound, a phenyltriazine-based compound, or a naphthalimide-based compound.

13. The method of claim 12, wherein the forming of the anti-reflective layer is performed in a vacuum chamber, and
the anti-reflective layer-forming material comprises the blue-light absorber and a fluorine-based acrylate compound.

14. The method of claim 13, wherein the forming of the anti-reflective layer comprises polymerizing the fluorine-based acrylate compound to form a polymerized fluorine-based acrylate compound and simultaneously depositing the polymerized fluorine-based acrylate compound and the blue-light absorber on the hard coating layer.

15. The method of claim 13, wherein the blue-light absorber and the fluorine-based acrylate compound are provided at an ion acceleration voltage of about 100 V to about 500 V.

16. The method of claim 12, wherein the forming of the anti-reflective layer is performed at a temperature of about −30° C. to about 10° C.

17. An electronic device comprising:
a display module comprising a first non-folding area, a second non-folding area, and a folding area between the first non-folding area and the second non-folding area; and
a window module disposed on the display module, the window module comprising a window glass and a protective film which are stacked in sequence,
wherein the protective film comprises:
a base layer;
a hard coating layer disposed on the base layer; and
an anti-reflective layer disposed on the hard coating layer,
wherein the hard coating layer or the anti-reflective layer comprises at least one blue-light absorber comprising a benzoxazole-based compound, a phenyltriazine-based compound, or a naphthalimide-based compound.

18. The electronic device of claim 17, further comprising at least one of a processor, a memory, or a power module.

19. The electronic device of claim 17, wherein the hard coating layer does not comprise the blue-light absorber, and
the anti-reflective layer comprises the blue-light absorber and a fluorine-based acrylate compound.

20. The electronic device of claim 17, wherein the blue-light absorber comprises at least one compound of Compound Group 1: [chemical structure]
